(19) United States
(12) Patent Application Publication
(10) Pub. No.: US 2004/0123534 A1
(43) Pub. Date: Jul. 1, 2004

(54) Security storm door

(76) Inventors: William M. Ferguson, Downey, CA (US); Steve H. Cutting, Manhattan Beach, CA (US)

Correspondence Address: BLANK ROME LLP, THE FARRAGUT BUILDING, SUITE 1000, 900 17TH STREET, NW, WASHINGTON, DC, 20006, US

(21) Appl. No.: 10/461,682

(22) Filed: Jun. 16, 2003

Related U.S. Application Data
(60) Provisional application No. 60/388,364, filed on Jun. 14, 2002.

(51) Int. Cl. E06B 1/04

(52) U.S. Cl. 52/204.1

(57) ABSTRACT

The invention provides a security storm door constructed of a tubular steel frame that is covered with a plastic cover. The cover snaps over the frame to provide aesthetic quality, to protect the integrity of the metal welds, and to accommodate framed window screens and/or glass sashes by having built-in channels. In a preferred embodiment, the cover is constructed of polyvinyl chloride (PVC). In a further embodiment, the cover has at least one channel to accommodate window screens and/or glass sashes. In a further embodiment, the cover has decorative elements such as contour molding or other shapes, designs and patterns.

### FIELD OF THE INVENTION

The present invention relates to a security storm door constructed of a tubular steel frame that is covered with a plastic cover. The cover snaps over the frame to provide aesthetic quality, to cover the metal welds, and to accommodate framed window screens and/or glass sashes by having built-in channels.

### BACKGROUND OF THE INVENTION

Security storm doors have been produced and utilized to provide personal safety and an extra measure of thermal and moisture insulation at door openings of a building. Some styles of storm doors are currently formed of one or more panes of glass seated within a surrounding metal door frame.

### SUMMARY OF THE INVENTION

The invention provides a security storm door constructed of a tubular steel frame that is covered with a plastic cover. The cover snaps over the frame to provide aesthetic quality, to protect the integrity of the metal welds, and to accommodate framed window screens and/or glass sashes by having built-in channels. In a preferred embodiment, the cover is constructed of polyvinyl chloride (PVC). In a further embodiment, the cover has at least one channel to accommodate window screens and/or glass sashes. In a further embodiment, the cover has decorative elements such as contour molding or other shapes, designs and patterns.

### BRIEF DESCRIPTION OF THE DRAWINGS

FIG. 1 shows the front view of the security storm door.

FIG. 2 shows the cross-section of the upper transverse rail member and a picket.

FIG. 3 shows the cross-section of the plastic cover.

FIG. 4 shows the cross-section of the upper transverse rail member covered with the plastic cover.

FIG. 5 shows the three-dimensional back view of the upper transverse rail member covered with the plastic cover.

FIG. 6 shows the three-dimensional front view of the upper transverse rail member covered with the plastic cover.

### DETAILED DESCRIPTION OF THE PREFERRED EMBODIMENT

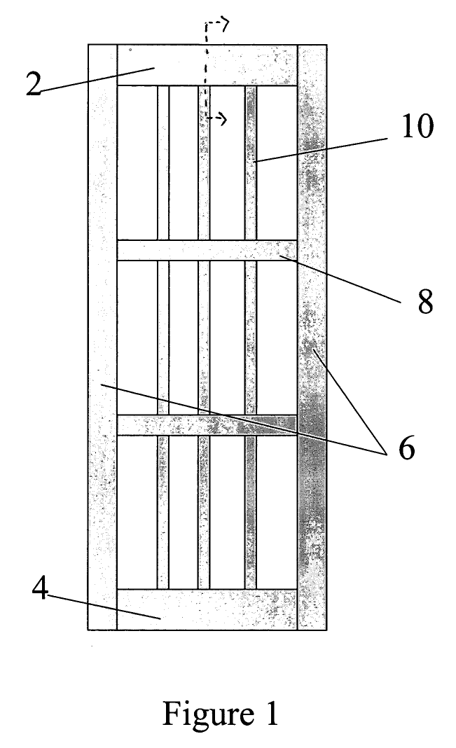

The frame of the door is formed of rectangular frames of heavy metal tubing, preferably galvanized tubular steel. FIG. 1 is a front view of a security storm door. As used herein, front refers to the side of the door that faces the outside when the door is installed in its normal configuration. The steel tubing is formed to create upright stile members (6) and upper and lower transverse rail members (2, 4) extending between the stile members. To create security, a grid of vertical and horizontal metal bars, collectively referred to herein as security bars, is provided in the rectangular opening defined by the stile (6) and rail members (2, 4). Some of these metal bars extending parallel to the stiles (6) are called pickets (10) and are anchored to the transverse rail members (2, 4) at the top and bottom of the door. Other metal security bars, called horizontal members (8) are oriented perpendicular to the door stiles (6) and are secured thereto. Additional decorative and angular metal bars can be provided as an adjunct to the rectilinear grid that functions to provide the door with a high level of security. It is the metal security bars, however, which provide security from unauthorized entry and which affords protection against burglary and home invasions.

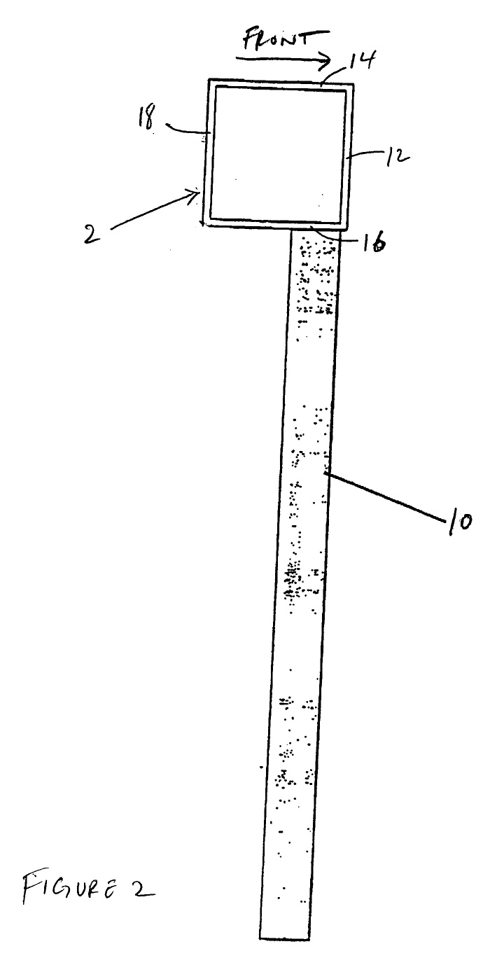

FIG. 2 shows a partial cross-section of the security storm door. The tubular steel frame (the upper transverse rail member (2) is shown in FIG. 2) preferably has a square cross-section having a front face (12), a top face (14), a bottom face (16), and a back face (18). The square cross-section has the dimension of about 1 to about 2 inches on each side, more preferably about 1.25 to about 1.75 inches, and most preferably about 1.5 inches. The steel used for the frame is preferably at least about 0.048 inch thick. The picket (10) and horizontal member (8) (only the picket (10) is shown in FIG. 2) are preferably constructed of tubular steel frame having a square cross-section of about 0.25 to about 1 inch on each side, preferably about 0.4 to about 0.7 inch, and most preferably about 0.5 inch. The steel used for the security bars is preferably at least about 0.042 inch thick. Being typically smaller than the frame, the pickets and horizontal members are preferably mounted as close to the front of the frame as possible (see FIG. 2).

The frame and security bars can be assembled by welding. Optionally, other methods of fastening may be employed, whether permanent or subject to disassembly.

Once assembled, the door is preferably powder coated with semi-gloss polyester. Although powder coating is preferred for its durability, other methods of painting well known in the art, such as wet spray, can also be used.

Once the frame is welded and painted, a cover can be applied to the exterior of the steel frame. The cover is a weather resistant plastic which snaps over the welded steel frame. The cover is preferably constructed of four pieces, each covering each of the upright stile members (6) and upper and lower transverse rail members (2, 4), welded together. The cover can be welded together prior to application. Alternatively, the four pieces, each matching each of the upright stile members (6) and upper and lower transverse rail members (2, 4), can be installed on the steel frame and then welded together. The purpose of the secondary door frame are three fold:

1) It is of a shape which add esthetic quality to the outside of the door. This is achieved through a series of bevels or contours in the plastic.

2) It covers the weld of the steel door frame to provide aesthetic quality.

3) It has built-in channels to accommodate framed window screens and/or glass sashes.

The cover preferably is constructed of a weather-resistant, extruded plastic, most preferably polyvinyl chloride (PVC).

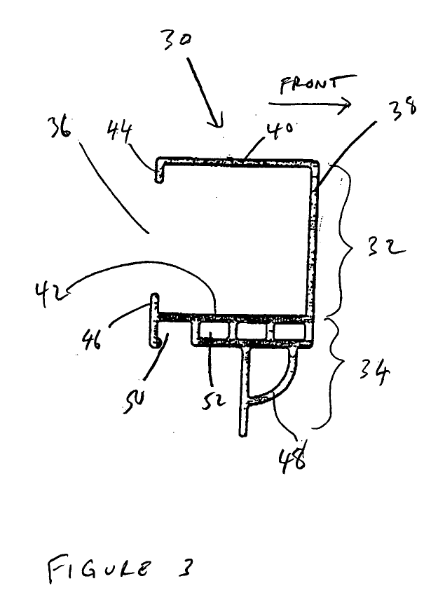

The cross section of a preferred cover (30) is shown in FIG. 3. For descriptive purposes, the cover is divided into two main sections, the main body (32) and the peripheral body (34). The main body (32) is the part of the cover that actual snaps on to the door frame. The main body (32) preferably has a square cross-section with a front wall (38), a top wall (40), a bottom wall (42), and a partially opened back side (36). The back side has upper and lower locking elements (44, 46). The dimension of the square cross-section preferably matches that of the frame so that the main body (32) conforms to the shape of the steel frame. The peripheral body (34) is located toward the center of the door from the main body (32) and comprises aesthetic and other functional elements of the cover. It is preferred that the peripheral body (34) is always located closer to the center of the door than the main body (32). For example, the part of the cover that covers the upper transverse rail member (2) has the peripheral body (34) below the main body (32); however, the part of the cover that covers the lower transverse rail member (4) has the peripheral body (34) above the main body (32). Aesthetically, the peripheral can have, for example, contour molding (48), or other decorative elements that can be molded into the cover (30). Although a contour molding (48) is shown in the figures, a variety of other shapes, designs, and patterns can be used. Toward the back of the peripheral body, behind the contour molding (48), at least one channel (50) can be located and configured to accept framed window screens and/or window sashes. Although, the channel shown in FIG. 3 is located at position 50, it can also be located at position 52. In an alternative embodiment, channels are located in both positions 50 and 52.

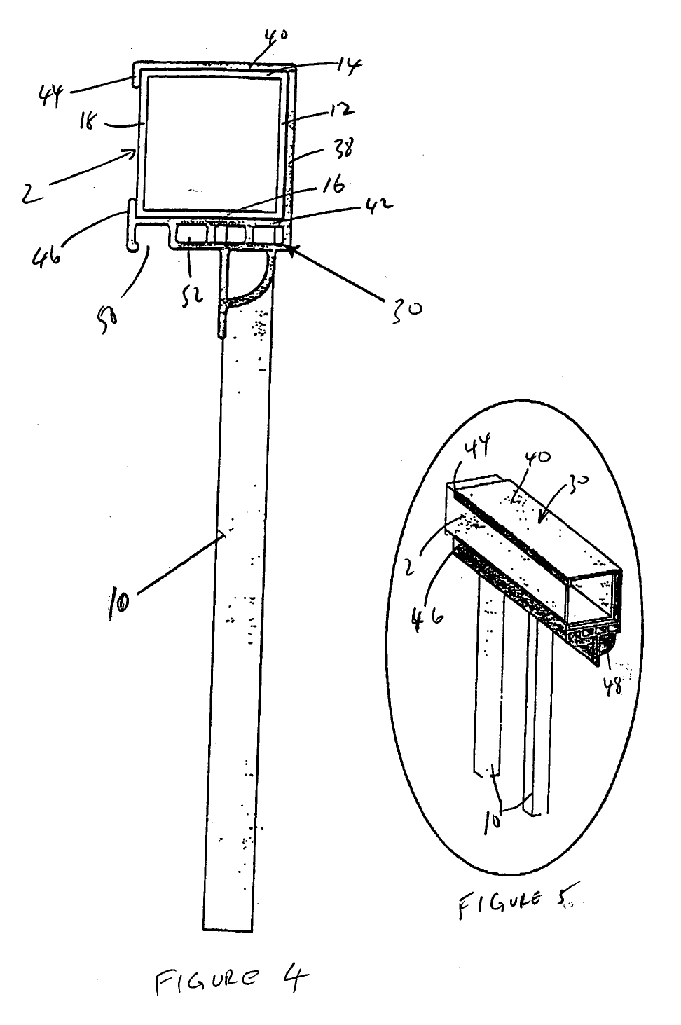

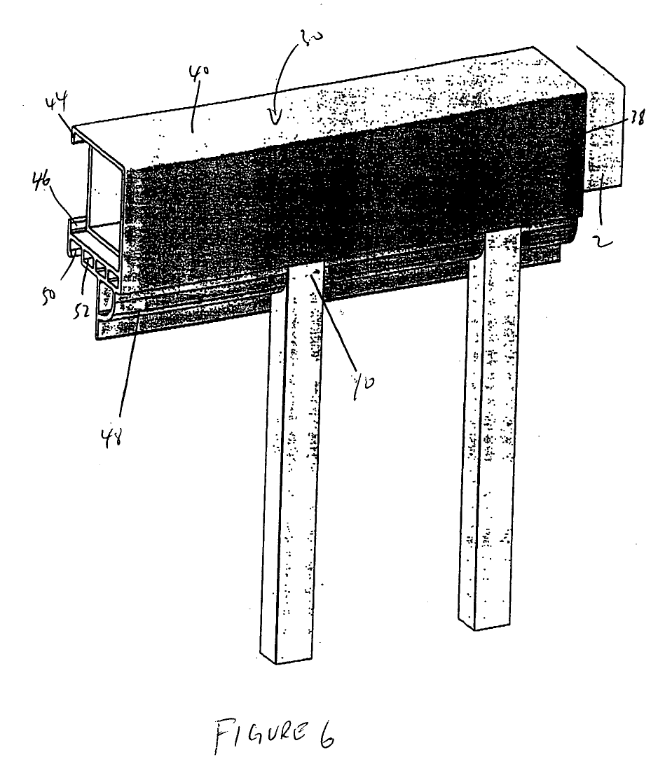

FIGS. 4-6 shows the cover (30) affixed to the upper transverse rail member (2) with FIG. 4 showing the cross-sectional view, and FIG. 5 and FIG. 6 showing the tree dimensional views from the back and the front, respectively. Although the figures only show the upper transverse rail member (2), the attachment is the same for the lower transverse rail member and the upright stile members. In this position, the cover conforms to the shape of the frame such that the front wall (38), top wall (40), and bottom wall (42) of the cover correspond to and locate adjacent to the front face (12), top face (14), and bottom face (16) of the frame, respectively. The upper and lower locking elements (44, 46), which extend the length of the rail member (2), latch to the back face (18) of the frame and secure the cover in place. If desired, a glue, adhesive, or fastener can be used to reinforce the coupling of the steel frame and the cover; however, this is not required as the cover can be held in place with just the locking elements (44, 46) alone.

In an embodiment of the present invention, the security storm door can also be provided with window screens and/or glass sashes to exclude insects and rodents and to provide additional insulation. The window screens and/or glass sashes are attached to and held in place with the channel (50).

In a preferred embodiment, the glass sashes can be opened to allow the user to select the level of ventilation permitted by the door. This is generally accomplished by sliding a portion of the door towards the other. For example, the top portion of the door can be open by sliding the upper glass sash down into the lower portion of the door. To accomplish this requires two channels in the part of the cover that covers the lower portion of the door. One channel accommodates the lower window sash and the other channel accommodates the upper window sash that has been slid down to the lower portion of the door. For this embodiment, the part of the cover that covers the lower portion of the door has channels in both positions 50 and 52, while the part of the cover that covers the upper portion of the door does not require two channels. However, for ease of manufacturing, it is practical to have two channels throughout the cover.

Although certain presently preferred embodiments of the invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extent required by the appended claims and the applicable rules of law.

What is claimed is:

1. A security storm door comprising
a frame, and
a plastic cover that covers said frame.

2. The security storm door of claim 1, wherein the plastic cover comprises at least one channel to accommodate window screens and/or glass sashes.

3. The security storm door of claim 1, wherein the plastic is PVC.

4. The security storm door of claim 1, wherein the plastic cover snaps over the frame.

5. The security storm door of claim 1, wherein the frame has a square cross section.

6. The security storm door of claim 1, wherein the frame is made of steel.

7. The security storm door of claim 1, further comprising a grid of security bars.

8. The security storm door of claim 1, wherein the frame comprises upright stile members and upper; and
lower transverse rail members extending between the stile members.

9. A method of making a security storm door comprising the steps of
providing a frame; and
covering said frame with a plastic cover.

10. The method of claim 9, wherein the plastic cover comprises at least one channel to accommodate window screens and/or glass sashes.

11. The method of claim 9, wherein the plastic is PVC.

12. The method of claim 9, wherein the plastic cover snaps over the frame.

13. The method of claim 9, wherein the frame has a square cross section.

14. The method of claim 9, wherein the frame is made of steel.

15. The method of claim 9, further comprising the step of providing a grid of security bars inside said frame.

16. The method of claim 9, wherein the frame comprises
upright stile members and upper; and
lower transverse rail members extending between the stile members.
